(19) United States
(12) Patent Application Publication
(10) Pub. No.: US 2007/0216225 A1
(43) Pub. Date: Sep. 20, 2007

(54) VEHICLE JUNCTION BOX AND METHOD OF CONTROLLING THE SAME

(75) Inventors: Jose Gabriel Fernandez, Valls (ES); Sergio Alquezar, Valls (ES)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/276,840

(22) Filed: Mar. 16, 2006

(51) Int. Cl. B60L 1/00

(52) U.S. Cl. 307/9.1

(57) ABSTRACT

A junction box having a number of relays for switching power from a power bus to a number of elements connected thereto. The junction box including a converter to control energy transfer from the power bus to a relay bus of the relays. The converter being controllable to provide power consumption and heat generation control.

### BACKGROUND OF THE INVENTION

1. Field of the Invention

The present invention relates to vehicle junction boxes and methods of controlling the same.

2. Background Art

In vehicles, junctions boxes are typically used to relay power between a primary power bus and one or more vehicle elements. The junctions boxes typically include a relay for each vehicle element such that power from the primary power bus is switched through the relay to the vehicle element associated therewith. One of the limiting parameters in junction box design is heat caused by power dissipation. The relays are one source of heat generation.

### SUMMARY OF THE INVENTION

One non-limiting aspect of the present invention relates to controlling energy provided to the relays so as to limit heat generation.

One non-limiting aspect of the present invention relates to controlling heat generation by controlling voltages provided to the relays such that a first voltage is provided during a pull-in operation associated with initially closing the relays and a second voltage is provided during a hold operation associated with maintaining closure of the closed relays.

One non-limiting aspect of the present invention relates to a junction box for use with a vehicle. The junction box may include a relay bus for delivering power from a power bus to one or more relays and a converter configured to selectably transfer energy from the power bus to the relay bus. The relays may be configured to relay the delivered power to other vehicle elements and the converter may be controlled so as to provide the relay bus with a first voltage during a pull-in operation associated with initially closing one or more of the relays and a second voltage during a hold operation associated with maintaining closure of the one or more closed relays.

One non-limiting aspect of the present invention relates to a method of operating a vehicle junction box having a number of relays for relaying power to a number of vehicle elements. The method may include selectably transferring energy from a power bus associated with a vehicle battery to a relay bus associated with the relays such that the relay bus is provided with a first voltage during a pull-in operation associated with initially closing one or more of the relays and a second voltage during a hold operation associated with maintaining closure of the one or more closed relays

One non-limiting aspect of the present invention relates to a controller configured to control a DC/DC converter used to transfer energy from a power bus to a relay bus used to transfer energy to a number of relays connected thereto. The controller may be configured to transfer energy from the power bus to the relay bus so as to provide the relay bus with a first voltage during a pull-in operation associated with initially closing one or more of the relays and a second voltage during a hold operation associated with maintaining closure of the one or more closed relays.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a power system in accordance with one non-limiting aspect of the present invention; and

FIG. 2 illustrates a flowchart of method of transferring energy in accordance with one non-limiting aspect of the present invention.

### DETAILED DESCRIPTION OF THE PREFERRED EMBODIMENT(S)

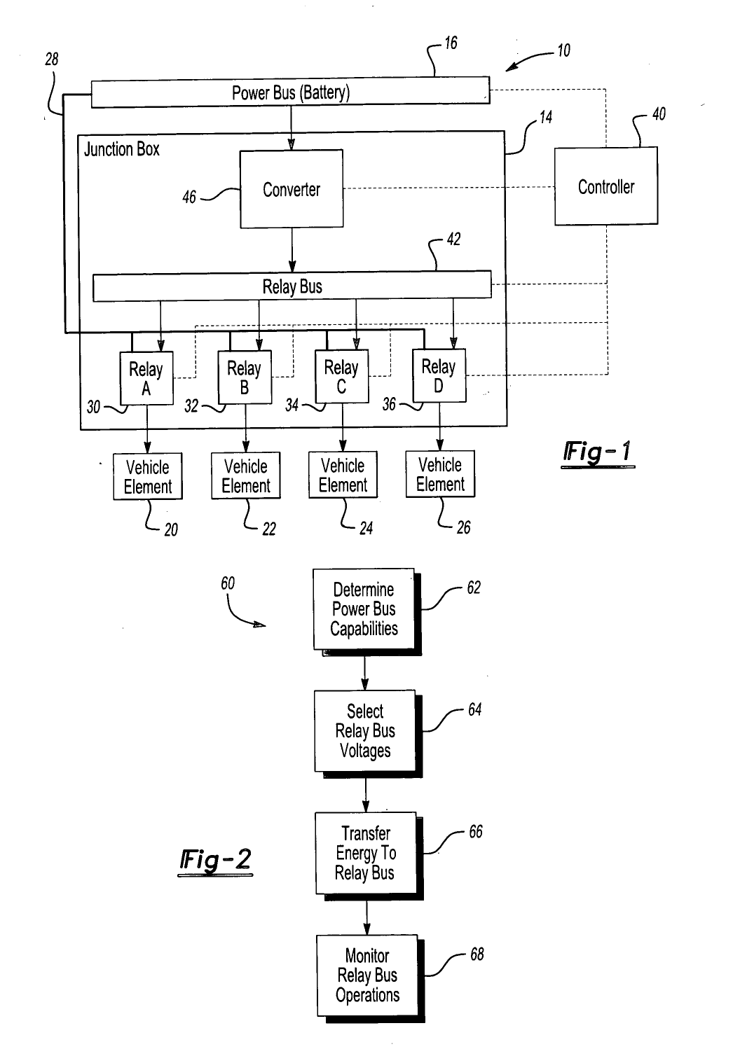

FIG. 1 illustrates a power system 10 in accordance with one non-limiting aspect of the present invention. The power system 10 schematically illustrates a portion of a common vehicle power system wherein a junction box 14 switches power from a primary power bus 16 to a number of vehicle elements 20-26. This arrangement is commonly employed in automobiles and other vehicles having a primary power bus 16 powered by a battery or other energy storage/generation element.

The present invention, for exemplary purposes, is explained with respect to the junction box 14 switching power to a number of vehicle elements 20-26. The vehicle elements 20-26 may be associated with any number of vehicle systems, sub-systems, components, features, etc. that require electric energy for operation, as one having ordinary skill in the art will appreciate, including smaller elements such as seat actuators and larger elements such as air conditioners, etc.

Of course, the present invention fully contemplates its use in other environments besides vehicles, such as industrial applications where the junction box 14 may be used to switch power to non-vehicle elements.

As shown, the junction box 14 includes a number of relays 30-36 to facilitate providing power to the vehicle elements 20-26. The relays 30-36 act as a switch to permit high, and in some cases low, current to flow from the power bus 16 to the vehicle elements 20-26 along a current path 28. A controller 40 or other feature may be in communication with each of the relays 30-36 to control the opening and closing thereof, i.e., the switching of power to the vehicle elements 20-26.

Accordingly, the relays 30-36 may be suitable switching elements having capabilities sufficient for controllably relaying power to the vehicle elements 20-26 such that the present invention is not intended to be limited to any particular type of relay. However, as described below in more detail, the present invention may be advantageous with coil-type relays where the coils connect to a relay bus 42 and contactors connect to the current path 28. These types of relays 30-36 tend to generate greater quantities of heat in proportion to supplied voltage levels.

A relay bus 42 may be included to provide energy from the power bus 16 to each of the relays 30-36 connected thereto. The relay bus 42 may comprise any number of materials, having any number of characteristics. Preferably, the relay bus 42 includes materials having high conductivity and capabilities to support high and low current draws.

A converter 46 may be included between the power bus 16 and the relay bus 42 to controllably transfer energy therebetween. The converter 46 may comprise a linear and/or non-linear converter having capabilities and characteristics to control energy flow to the relay bus 42 in accordance with the present invention. In vehicular applications, for example, the power bus may be a DC bus such that the converter may be DC/DC converter.

The converter 46 may be programmed to control energy conversion between the power bus 16 and relay bus 42. Likewise, the controller 40 may be configured to instruct or otherwise selectively control operation of the converter 46. In this manner, either the converter 46 itself or the controller 40 may selectively control energy flow from the power bus 16 to the relay bus 42.

This allows the present invention to selectively control the voltage of the relay bus 42, referred to as a relay bus voltage, and thereby, the power consumption of the relays/junction box. For exemplary purposes, the controller 40 is hereinafter referred for controlling converter operations, however, the present invention fully contemplates the features of the controller 40 being integrated within the converter 46.

As one having ordinary skill in the art will appreciate, the relay bus 42 must operate at a particular nominal voltage level in order to permit closing of the relays 30-36. This nominal voltage varies as a function of the relay 30-36 characteristics and the vehicle elements 20-26 associated therewith, but generally the nominal voltage is around 12V for automotive vehicle operations.

Once the relays 30-36 are closed, however, the relay operating characteristics may allow the relays 30-36 to remain closed at some voltage less than the nominal voltage. As such, some relay bus voltage less than the nominal 12V may be sufficient to keep the relays 30-36 closed, depending on the type of relay 30-36 and the vehicle element 20-26 associated therewith, but generally this lower voltage is around 8V for automotive vehicle operations.

The present invention takes advantage of these relay characteristics to reduce junction box power consumption and heat generation. In more detail, the present invention contemplates varying the relay bus voltage in accordance with the voltage differential associated with initially closing and maintaining closure of the relays 30-36 so as to reduce the voltage supplied to the relays 30-36, and thereby, the junction box power consumption and heat generation.

For the purposes of the present invention, the initial closing of one or more of the open relays 30-36 may be referred to as a pull-in operation and the maintenance of the closed relays 30-36 may be referred to as a hold operation. To take advantage of the voltage differentials during the two operations, the controller 40 may be configured to control the relay bus 42 to a first voltage during the pull-in operation (pull-in voltage) and to second voltage during a hold operation (hold voltage). The second voltage being less than the first voltage such that the reduction in voltage reduces the power consumption of the relays/junction box and improves overall system performance.

As noted above, each relay 30-36 may be associated with different pull-in and hold voltage characteristics, depending on the relay type and the vehicle element 20-26 associated therewith. The voltages supplied to the relay bus 42 during the pull-in and hold operations may vary as a function of the active relays 30-36 and their individual characteristics, i.e., the relay bus voltage may vary according to which one or more of the relays 30-36 are closed and/or to be closed. The ability to vary the relay bus voltage allows the controller 40 to execute any number of control strategies.

One control strategy may relate to setting different pull-in and hold voltages depending on the relays 30-36 to be closed. For example, if all the relays 30-36 are open, and only relay A is to be closed, the controller 40 may control the voltage variations during activation of relay A to vary according to a first set of pull-in and hold voltages associated with only relay A. Conversely, if relay B is to be closed at the same time as relay A, then the controller 40 may control the voltage variations according to a second set of pull-in and hold voltages determined as a function of relay B and A, namely the greatest voltage demands are selected to insure operation of both relay A and B.

Another control strategy relates to adjusting the relay bus voltage after one or more relays 30-36 are closed and another is to become active. For example, if relay A is the only active relay, i.e., it is already closed, the activation of relay C may require the controller to adjust the relay bus voltage to the pull-in voltage of relay C so as to permit the closing thereof. This may include raising the relay bus voltage if the nominal voltage of relay C is greater than the hold voltage used to maintain closure of relay A. Thereafter, the relay bus voltage may be further adjusted according to the hold voltage of relay C, which may be greater than the hold voltage of relay A such that some power and heat value is lost, and if it is less, then the hold voltage of relay A is used.

Another control strategy may relate to deactivating (opening) one or more of the active (closed) relays 30-36. For example, if relays A, C, and D are active and one or more of them is to become inactive, the controller 40 may adjust the hold voltage to the hold voltage of the highest drawing relay of the remaining active relays so as to permit a reduction in the hold voltage. This allows the present invention to take advantage of further reductions in voltage levels and power consumption for the lower hold voltage.

Another control strategy may include deactivating one or more relays 30-36 as a function of power bus 16 energy capabilities. As one having ordinary skill in the art will appreciate, the power bus 16 may be susceptible to changes in energy capabilities such that it may not be able to support operations associated with the relays 30-36. For example, if the voltage of the power bus 16 drops below the pull-in voltage of one or more of the relays 30-36, then the controller 40 may generate a warning or take other action to indicate the inability to active of the associated vehicle element.

Likewise, if the power bus voltage remains above the hold for one or more of the relays 30-36 but below their pull-in voltage, the controller 40 may take actions to keep the relay(s) 30-36 closed in order to maintain functionality of the associated vehicle elements and/or it may generate a warning to indicate the inability to re-start the associated vehicle elements 20-26 should the relays associated therewith be opened.

Furthermore, the controller 40 may take corrective action if the power capabilities of the power bus 16 indicate an inability to maintain continued action of the currently active relays 30-36. This may include the controller 40 opening relays of less-essential vehicle elements 20-26 in order to prolong operation, and/or if the power bus voltage is likely to drop below the hold voltage of the active relays 30-36, the controller 40 may generate a warning to indicate imminent loss of the associated vehicle elements, such as to warn a driver to pull over, etc.

The controller 40 may be configured to monitor which one or more of the relays 30-36 are to be active and to control the relay bus voltage accordingly. Likewise, the controller 40 may be configured to vary the relay bus voltage depending on newly activated and/or inactive relays 30-36. In all cases, however, the controller 40 may be configured to assess the voltage demands of each active relay 30-36 and the power bus 16 and to control the relay bus voltage according to the worst case demands of all the active features. This may require the controller 40 to select the first voltage to corresponding with a pull-in voltage of the relay 30-36 having the greatest pull-in voltage demand and to select the second voltage to corresponding with a hold voltage of the relay 30-36 having the greatest hold voltage demand.

FIG. 2 illustrates a flowchart 60 of method of transferring energy from the power bus 16 to the relay bus 42 in accordance with one non-limiting aspect of the present invention. The method may be embodied in a computer-readable or other executable medium associated the converter 46 and/or controller 40 and useable by the same for executing the operations associated with the present invention and the method described below.

Block 62 relates to determining powering capabilities of the power bus 16. This may include monitoring operations of a battery associated therewith and/or otherwise monitoring the operation thereof, including determining a power bus voltage and other operating characteristics associated with the energy characteristics and performance of the power bus 16.

Block 64 relates to determining a desired relay bus voltage as a function of relays 30-36 to be closed or kept active and their operating characteristics. The desired relay bus voltage may correspond with one or more voltages depending on the desired operation of the junction box 14. As described above, the relay bus voltages may be determined in sets, one for a pull-in operation and another for a hold operation, and optionally, such voltage sets may be determined for each relay, with the voltages associated with highest drawing relays being selected.

Block 66 relates to controlling the converter 46 to provide the relay bus voltages selected in Block 64 if the energy capabilities of the power bus 16 determined in Block 62 are sufficient. This may include coordinating variations in the relay bus voltage with closing of the relays 30-36, namely according to the voltage variations associated with the pull-in and hold operations. The controller 40 may be in communication with the relays 30-36 and other inputs associated with the operation thereof to coordinate selection of the active relays and the sequence in which they are closed.

Block 68 relates to monitoring operation of the relays 30-36 and adjusting the relay bus voltage as a function thereof so as to take advantage of any energy saving opportunities. This may include adjusting the relay bus voltage according to newly activated and/or deactivated relays 30-36 and/or operational capabilities of the power bus 16 so as to take advantage of any power saving opportunities while maintaining desired operation of the junction box 14 and relays 30-36.

In more detail, this may include: raising the relay bus voltage to permit closure of previously opened relays 30-36 and then immediately readjusting the relay bus voltage to an appropriate hold voltage for the newly closed relay 30-36 and previously closed relays 30-36; lowering the relay bus voltage upon opening a previously closed relay 30-36 having a higher hold voltage than the currently active relays 30-36; and/or any number of other variations in accordance with the present invention. Likewise, this may include taking corrective action and/or other measures in light of the power bus energy capabilities determined in Block 62, such as providing warnings and adjusting the active relays, as described above in more detail.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A junction box for use with a vehicle, the junction box comprising:
a relay bus for delivering power from a power bus to one or more relays, the relays configured to relay the delivered power to other vehicle elements; and
a converter configured to selectably transfer energy from the power bus to the relay bus so as to provide the relay bus with a first voltage during a pull-in operation associated with initially closing one or more of the relays and a second voltage during a hold operation associated with maintaining closure of the one or more closed relays.

2. The junction box of claim 1 wherein the second voltage is less than the first voltage so as to reduce power consumption of the junction box after initially closing the one or more relays.

3. The junction box of claim 1 wherein the converter is configured to receive signals from a controller for selectably controlling energy delivery between the power bus and the relay bus.

4. The junction box of claim 1 wherein the second voltage is selected as a function of one or more of the vehicle elements associated with the one or more relays closed with the first voltage.

5. The junction box of claim 4 wherein the second voltage is selected to correspond with the relay requiring the greatest hold voltage to support the vehicle element associated therewith.

6. A method of operating a vehicle junction box having a number of relays for relaying power to a number of vehicle elements, the method comprising:
selectably transferring energy from a power bus associated with a vehicle battery to a relay bus associated with the relays such that the relay bus is provided with a first voltage during a pull-in operation associated with initially closing one or more of the relays and a second voltage during a hold operation associated with maintaining closure of the one or more closed relays

7. The method of claim 6 further comprising limiting power consumption during the hold operation by limiting the second voltage to a value less than the first voltage of the pull-in operation.

8. The method of claim 6 further comprising selecting the first voltage to corresponding with a pull-in voltage of the relay having the greatest pull-in voltage demand.

9. The method of claim 6 further comprising selecting the second voltage to corresponding with a hold voltage of the relay having the greatest hold voltage demand.

10. The method of claim 6 further comprising controllably selecting one or more active relays, the active relays being controlled to close during the first voltage and to remain closed during the second voltage.

11. The method of claim 10 further comprising selecting the first and second voltages as a function of the active relays.

12. The method of claim 11 further comprising selectively inactivating at least one of the active relays and adjusting the second voltage as a function of the remaining active relays.

13. The method of claim 11 further comprising activating a previously inactive relay and adjusting the second voltage as a function of the previously and newly active relays.

14. The method of claim 10 further comprising selectively inactivating at least one of the active relays in response to a power drop in the power bus.

15. The method of claim 14 further comprising selecting the inactive relay as a function of the vehicle element associated therewith.

16. A controller configured to control a DC/DC converter used to transfer energy from a power bus to a relay bus used to transfer energy to a number of relays connected thereto, the controller configured to:
transfer energy from the power bus to the relay bus so as to provide the relay bus with a first voltage during a pull-in operation associated with initially closing one or more of the relays and a second voltage during a hold operation associated with maintaining closure of the one or more closed relays.

17. The controller of claim 16 further configured to adjust the relay bus voltage as a function of relays becoming active or inactive after providing the second voltage.

18. The controller of claim 16 further configured to take corrective action if the power bus lacks sufficient power to maintain desired operation of the relays.

19. The controller of claim 18 wherein the corrective action includes generating a warning.

20. The controller of claim 18 wherein the corrective action includes opening one of the closed relays.
